(19) United States
(12) Patent Application Publication
(10) Pub. No.: US 2014/0180732 A1
(43) Pub. Date: Jun. 26, 2014

(54) System And Method For Arranging Aggregated Unscheduled Transport Service

(71) Applicant: BLACKJET, INC., West Palm Beach, FL (US)

(72) Inventors: Dean ROTCHIN, Loxahatchee, FL (US); Joseph GRIMES, Stuart, FL (US)

(73) Assignee: BLACKJET, INC., West Palm Beach, FL (US)

(21) Appl. No.: 13/724,781

(22) Filed: Dec. 21, 2012

(51) Int. Cl. G06Q 10/02

(52) U.S. Cl. CPC G06Q 10/02
USPC 705/5

(57) ABSTRACT

A method for booking transport on an aggregated transport service comprises receiving an indication of an origin, a destination, and a date of transport for transport on an aggregated transport service, determining a price for the indicated transport, transmitting information relating to the origin, destination, price, and the date of transport, receiving an indication that transport using the origin and destination, for the determined price and on the date of transport has been accepted, in response to receiving the indication that the transport has been accepted, and before a vehicle to provide the indicated transport has been determined, arranging for payment for the transport and transmitting a confirmation of the booking of the indicated transport, before the indicated transport occurs, determining a vehicle to provide the indicated transport, and when the indicated transport is completed, capturing the arranged payment.

### BACKGROUND OF THE INVENTION

1. Field of the Invention

The present invention relates to a system, method, and computer program product for arranging aggregated transport service.

2. Description of the Related Art

Since the advent of the US air mail routes in the early 1900's aircraft operators sought opportunities to fill empty space or seats on flights in order to increase revenue or defray costs associated with operating the air service. In the past, a traveler would investigate schedules and book seats on scheduled transport services, or they would arrange for travel services according to their particular need by chartering an aircraft. Travelers chartering the entire aircraft, rather than booking a seat on the aircraft, would be faced with very high cost. More recently, it became possible for travelers to post their travel requirements with online services, and attempt to match other travelers with similar travel requirements and try to share a charter aircraft and split the cost. There have been some services that attempt to have an initial traveler charter an aircraft, and then post the booking to a website and attempt to find a match and sell empty seats on the chartered aircraft to defray some cost and provide the opportunity to reduce the overall cost to the original traveler. In such an arrangement the monetary risk of unfilled seats was borne by the original traveler, while in other arrangements, the monetary risk of unfilled seats was borne by the charter operator, travel coordinator, seat reseller, or by no one as the charter was only booked if and when other travelers agree to share the charter aircraft with the original traveler. While the marginal cost of filling an empty seat on an aircraft that is going to fly anyway is quite low and there is great incentive for the entity bearing the monetary risk of empty seats to fill those seats, there are logistical and regulatory limitations adversely affecting the success of these strategies. Historically, and to date, conventional booking techniques used by such services are difficult to use and are inefficient, resulting in empty seats on many flights. Much of this is due to governmental regulations in the United States and in other countries relating to scheduled versus unscheduled transportation, especially those that prohibit an aircraft operator, charter broker, online service or even the charter customer from arranging an aircraft that will be operated in an on demand versus scheduled regulatory and logistics regime, irrespective of aircraft size or ownership category, and generally known as “general aviation” and then using any method to fill empty seats on that aircraft.

A need arises for a technique for arranging aggregated unscheduled transport service that provides improved usability and efficiency.

### SUMMARY OF THE INVENTION

A system, method, and computer program product provides a technique for arranging aggregated unscheduled transport service that provides improved usability and efficiency. Using this technique, clients of an unscheduled transport service can quickly and easily arrange for aggregated unscheduled transport services, such as charter aircraft, and other types of vehicles. Using the techniques of the present invention, clients who are passengers with similar travel requirements are aggregated before the vehicle is determined. This provides the capability to tailor the provided vehicle to the number of passengers and other factors.

The technique of the present invention recognizes the fact that there is a vast fleet of unscheduled aircraft which are generally under-utilized. These aircraft cannot be operated according to a published schedule, but rather are required to be operated on-demand or in unscheduled service also known as private (as opposed to public) charter. Typically, there are a large number of unscheduled aircraft available to provide transport at any given time. The present invention effectively utilizes this characteristic of the private charter market by guaranteeing transport based on passengers' booking requirements to one or more passengers, and then arranging for the charter of the aircraft a short time before departure. This improves the ease of use for the passengers because their travel arrangements and price are guaranteed at the time of booking. Efficiency and cost are also improved by matching the aircraft to be chartered to the aggregated passengers who will be traveling. The techniques of the present invention are equally applicable to transport services using any type of equipment transporting passengers and goods.

In addition, social media aspects for the present invention provide the capability for friends, family, colleagues, and others with some relation to a client, to be invited to travel and to quickly and easily arrange transport and other services themselves.

For example, a method for booking transport on an aggregated unscheduled transport service may comprise receiving an indication of an origin, a destination, and a date of transport for transport on an aggregated transport service, determining a price for the indicated transport, transmitting information relating to the origin, destination, price, and the date of transport, receiving an indication that transport using the origin and destination, for the determined price and on the date of transport has been accepted, in response to receiving the indication that the transport has been accepted, and before a vehicle to provide the indicated transport has been determined, arranging for payment for the transport and transmitting a confirmation of the booking of the indicated transport, before the indicated transport occurs, determining a vehicle to provide the indicated transport, and when the indicated transport is completed, capturing the arranged payment.

The method may further comprise before determining the vehicle to provide the transport, aggregating a plurality of confirmed bookings based on factors at least one of a date of departure, the departure location, and the arrival location, and determining the vehicle to provide the transport based on the aggregated plurality of confirmed bookings. The aggregated unscheduled transport service may be an aircraft charter operator, a broker, a travel agent, a directory type service or other intermediary. The vehicle may be determined based on at least one of an origin or destination of the transport, a distance between the origin and destination of the transport, the date of transport, the cost of the transport, availability of particular vehicles, an amount of time until the transport is to occur, a number of people who will travel on the same equipment, and special requests of any of the travelers. The vehicle may be determined based on a bidding process in which vehicle operators are informed of a transport need based on the confirmed bookings and the vehicle operators then bid for the right to provide the transport service.

For example, a method for booking transport on an aggregated unscheduled transport service may comprise accepting and transmitting input of an indication of an origin, a destination, and a date of transport for transport on an aggregated transport service wherein no vehicle has been determined for performing the transport; and accepting and transmitting an indication that transport using the origin and destination, for the determined price, and on the date of transport has been accepted. The aggregated unscheduled transport service may be an aircraft charter operator, a broker, a travel agent, a directory type service or other intermediary. The method may be implemented as an application on a mobile device, a web application, or a mobile web application.

For example, a method for booking transport on an aggregated unscheduled transport service may comprise receiving information relating to an origin, a destination, and a date of transport for transport on an aggregated transport service, determining a price for the indicated transport, in response to receiving an indication that the transport has been accepted, and before a vehicle to provide the indicated transport has been determined, confirming booking of the transport, before the transport occurs, determining a vehicle to provide the transport, and when the transport is completed, capturing payment for the transport.

For example, a method for booking transport on an aggregated unscheduled transport service may comprise accepting information relating to an origin, a destination, and a date of transport for transport on an aggregated transport service wherein no vehicle has been determined for performing the transport and confirming booking of the transport.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram in which the techniques of the present invention may be utilized.

FIG. 2a is an exemplary flow diagram of a process of arranging for one or more seats on an aggregated unscheduled transport service.

FIG. 2b is an exemplary flow diagram of a process of aggregating unscheduled transport service.

FIGS. 3a-3k, are illustrations of exemplary display screens illustrating steps in the process shown in FIG. 2.

FIG. 4 shows an exemplary user interface for a mobile application for booking one or more seats on an aggregated unscheduled transport service.

FIG. 5 is exemplary block diagram of a mobile device, in which a software application or mobile app for booking seats on an aggregated unscheduled transport service may be implemented.

FIG. 6 is exemplary block diagram of a computer system, in which an aggregated unscheduled transport booking service system may be implemented.

### DETAILED DESCRIPTION OF THE INVENTION

A system, method, and computer program product provides a technique for arranging aggregated unscheduled transport service that provides improved usability and efficiency. Using this technique, clients of an aggregated unscheduled transport service can quickly and easily arrange for unscheduled transport services, such as charter aircraft, and other types of transport. Additional advantages and features are described below.

The technique of the present invention recognizes the fact that there is a vast fleet of unscheduled aircraft which are generally under-utilized. These aircraft cannot be operated according to a published schedule, but rather are required to be operated on-demand or in unscheduled service also known as private (as opposed to public) charter. This means that typically, there are a large number of unscheduled aircraft available to provide transport at any given time. The present invention effectively utilizes this characteristic of the private charter market by guaranteeing transport based on passengers' booking requirements to one or more passengers, and then arranging for the charter of the aircraft a short time before departure. This improves the ease of use for the passengers because their travel arrangements and price are guaranteed at the time of booking. Efficiency and cost are also improved by matching the aircraft to be chartered to the aggregated passengers who will be traveling.

In addition, social media aspects for the present invention provide the capability for friends, family, colleagues, and others with some relation to a client, to be invited to travel and to quickly and easily arrange transport themselves, in addition to other services.

The techniques of the present invention enable travelers to book their seats, either independently or in coordination with each other, and receive a confirmation of guaranteed transport. At some time before the transport is to occur, the booking agent/broker/operator takes the bookings and determines, arranges for and provides aircraft or multiple aircraft based upon aggregating the number of people traveling with similar travel requirements.

From the client's perspective, they book travel and receive confirmations, but there is no specific aircraft reserved at that time. At some time before the confirmed travel date/time, preferably shortly before, the organization guaranteeing/providing seat availability arranges for the aircraft, or other vehicle, required to transport the traveler or travelers and provides an itinerary specifying the airport, departure times, aircraft type, and other itinerary particulars.

This is in contrast to conventional aircraft charter services in which the flight of the aircraft was arranged in response to a client request and the travel service providers could then offer seats for sale on the already arranged or scheduled aircraft. Using this new technology, booking is confirmed and guaranteed when passengers book and then the aircraft, or other vehicle required to provide the transport, is arranged in response to the bookings. The technology is not dependent on real-time aircraft or seat availability information, and does not match seat requests to available seats or available aircraft—rather it provides predetermined seat pricing and bookings and then locates and selects aircraft and provides final itineraries at an interval prior to the flights.

Additional examples of advantages provided by the techniques of the present invention include:

The technique of selling seats/space and then subsequently providing a vehicle provides for better optimization of vehicle size to actual demand. For example, if 8 seats are sold, an 8 seat vehicle can be provided, while if 19 seats are sold, a 19 seat vehicle can be provided. In addition, since the seats/space are sold on a guaranteed or “ever green” basis, there is no inventory constraint and all customer's booking requests can be accepted immediately, thus increasing usability, customer satisfaction and sell through.

Pricing is determined in advance and is not dependent upon vehicle selection. Thus, the ability to provide pricing without actual inventory or commitments from operators for a particular trip allows for immediate convenient booking and greater sell through.

Clients can agree to flexibility including service parameters such as departure time, airports, and aircraft, allowing for aggregation and greater optimization.

Selling seats to clients can provide lower prices for each client as compared to each client chartering the entire vehicle, and greater potential revenue for operators and stakeholders since on the aggregate, per flight revenue can be greater. For example, if three clients each pay 50% of the expected price to charter the vehicle, each client saves 50%, but generates 150% of the revenue based on the expected price to charter the entire vehicle.

Since vehicles are not committed until shortly before departure, the ability to modify and optimize travel arrangements up to a short period prior to departure can be provided based on agreed upon flexibility parameters which can also be adjusted by geographic location, time of day, seasonality, demand, market conditions and other factors, allowing for increased optimization.

The ability to publish guaranteed pricing eliminates a lag time between when a client places a travel request and when it is confirmed, which improves the customer's experience, and increases sell through,

Matching customers with aircraft/vehicles after they have been aggregated mitigates the financial risk of pre-arranging a potentially inappropriately sized or configured vehicle or vehicle type as opposed to matching the vehicle to the required capacity after aggregation.

The techniques of the present invention provide inherent capacity advantages by accessing an entire fleet of vehicles as opposed to being constrained by a dedicated fleet. Further, this provides the ability to match travel requirements with optimally located vehicles by selecting from the entire fleet as opposed to a dedicated or limited fleet.

The techniques of the present invention provide the ability to offer and deliver seats based on pricing that is a fraction of the pricing for the entire vehicle. As a result, many more clients can afford and access the transport service thus creating economies of scale and more operating hours per vehicle. This defrays the fixed vehicle cost, lowers the effective hourly rate, and provides greater optimization for the operator.

The social aspects of the technology provide much greater ability to invite friends, thus increasing aggregation. Also the ability to instantly gratify the inviter with benefits increases the effectiveness of the invite system and delivers more clients and greater aggregation. The social invite system can act as a proxy for a published schedule; when clients invite through social media, they broadcast their itineraries. Even though the aircraft operator, charter broker, agent, directory service or other stakeholder are not publishing schedules, the clients are broadcasting their travel itineraries. While some regulatory regimes limit the direct or indirect operator from publishing schedules, there is no regulation prohibiting customers from inviting friends to join a trip. The invite system allows an easy frictionless way for clients to broadcast their travel and invite others, which greatly reduces or eliminates the need for an operator, agent, broker directory service or other stakeholder from publishing a schedule. In addition, the added benefits associated with not having a vehicle scheduled when the client is broadcasting their itineraries, thus effectively complies with the regulations as empty seats on a vehicle are not being sold, just an aggregation of clients and their needs, prior to arranging transport.

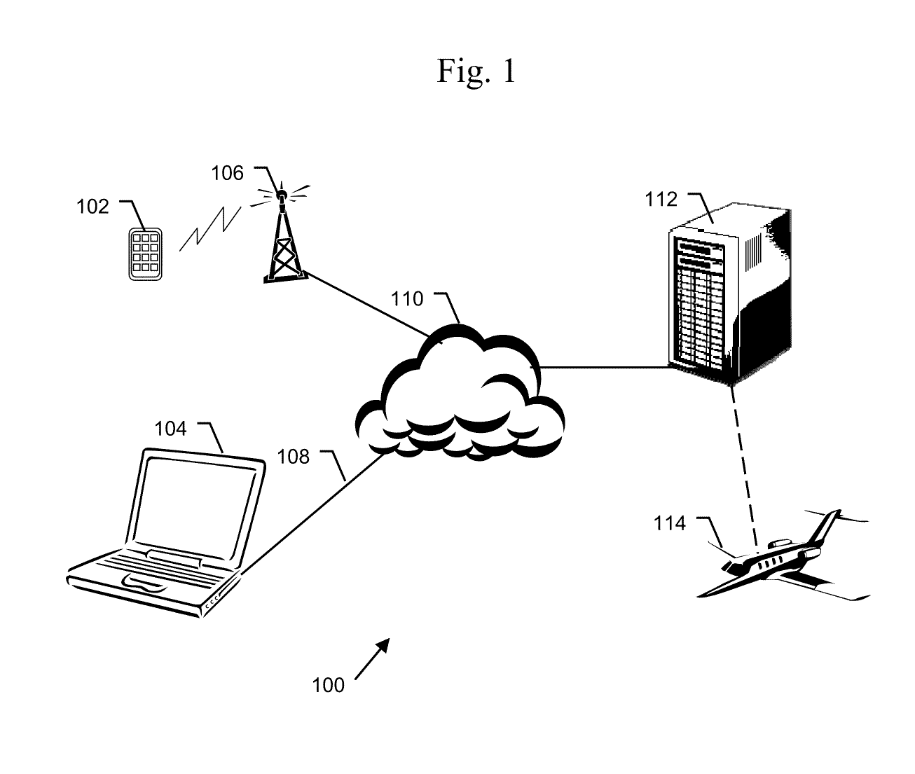

An example of a system 100 in which the techniques of the present invention may be utilized is shown in FIG. 1. System 100 includes one or more client devices, such as mobile device 102 or computer system 104. Mobile device 102 is typically a small, hand-held computing device, generally having a display screen with touch input and/or a miniature keyboard, and wireless 106 and/or wired (not shown) communication capability. Such devices typically have operating systems (OS), and can run various types of application software, known as apps. Examples of such devices include, but are not limited to smartphones, feature phones, tablet computers, personal digital assistant, portable media players, etc. Computer system 104 is typically a programmed general-purpose computer system, such as a personal computer or workstation. Computer system 104 generally has a display screen, user input devices such as a mouse and keyboard, and wireless (not shown) and/or wired 108 communication capability. Computer system 104 typically has operating systems (OS), and can run various types of application software, known as apps. One or more apps implementing functionality included in the present invention, such as booking one or more seats on an aggregated transport service 114, may be run on client devices, such as mobile device 102 or computer system 104. It is to be noted that mobile device 102 and computer system 104 are merely examples of devices which may be used by the present invention. The present invention contemplates the use of any device having user input and output capabilities, and communication capabilities.

Client devices, such as mobile device 102 or computer system 104 may communicate with other devices and with each other over network 110. Network 110 may be any standard local-area or wide-area communications or telecommunications network, whether wired or wireless, or public, private, or proprietary. Typically network 110 may include the Internet, along with one or more other networks. In particular, network 110 may provide communications with an aggregated transport booking service system 112. Unscheduled transport booking service system 112 is typically a programmed general-purpose computer system, such as a personal computer, workstation, server system, or minicomputer or mainframe computer. Unscheduled transport booking service system 112 performs the backend processing needed to implement functionality included in the present invention in communication with the client devices. Such functionality may include booking one or more seats on an aggregated transport service 114. Unscheduled transport service 114 may include such forms of transportation as charter aircraft, and other types of transport. For example, transport service 114 may include aircraft operated in an on demand versus scheduled regulatory and logistics regime irrespective of aircraft size or ownership category in the US and in general known as “general aviation”, but could also include airliners (size category) operated on-demand as opposed to scheduled service. The present invention contemplates application to any type of unscheduled transport service or vehicle. In addition, techniques in accordance with the present invention may be applied to any type of “group then go” or “group then buy” arrangement, in addition to seats on transport.

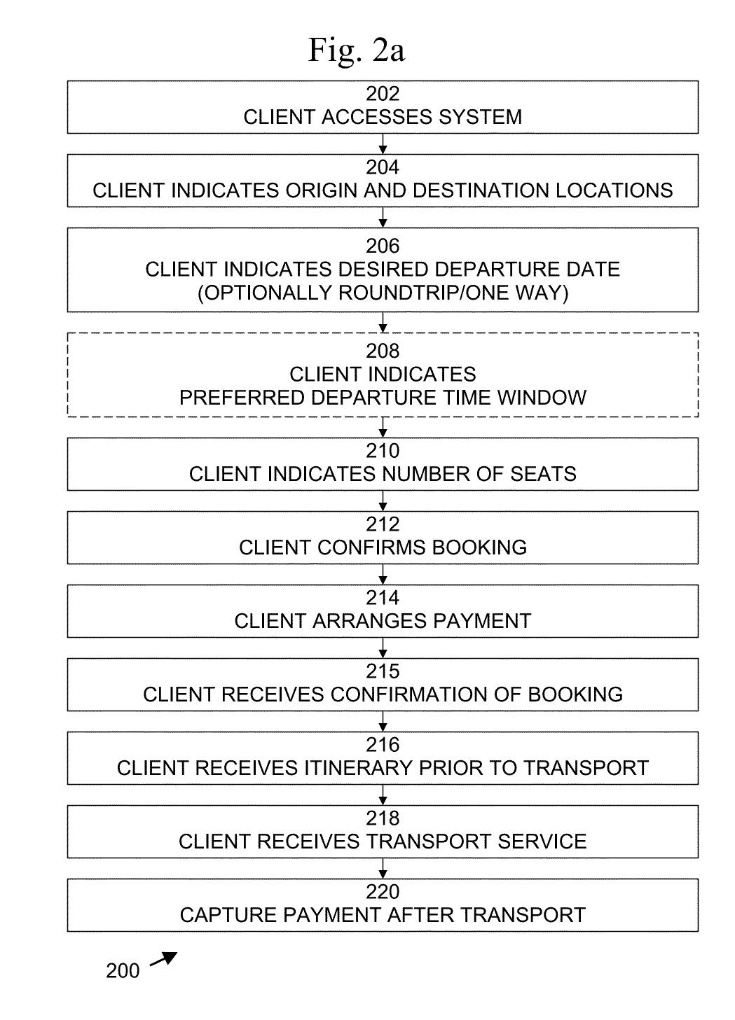

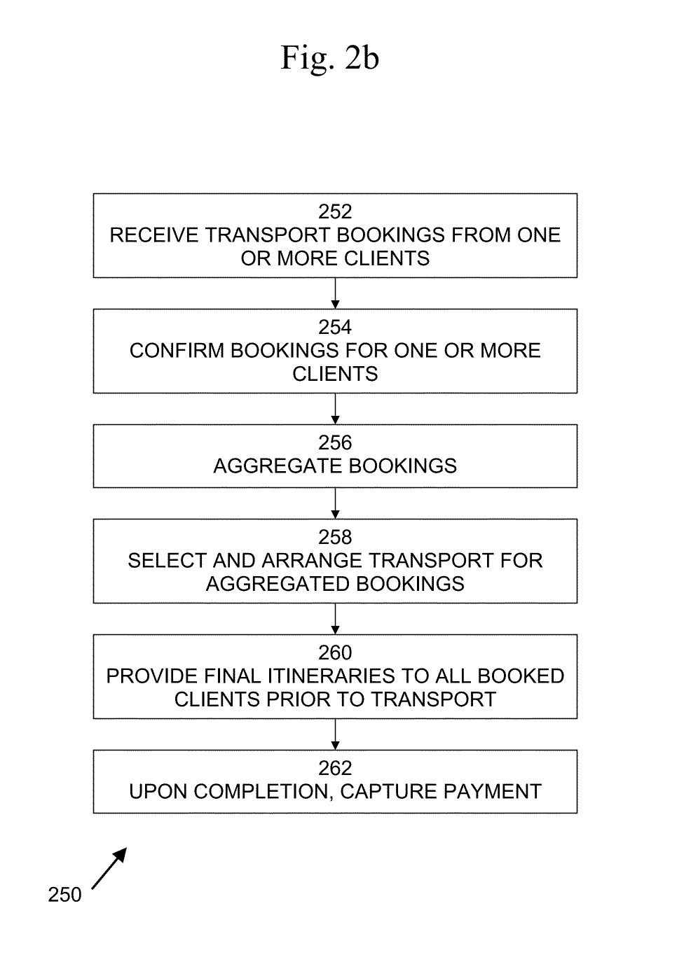

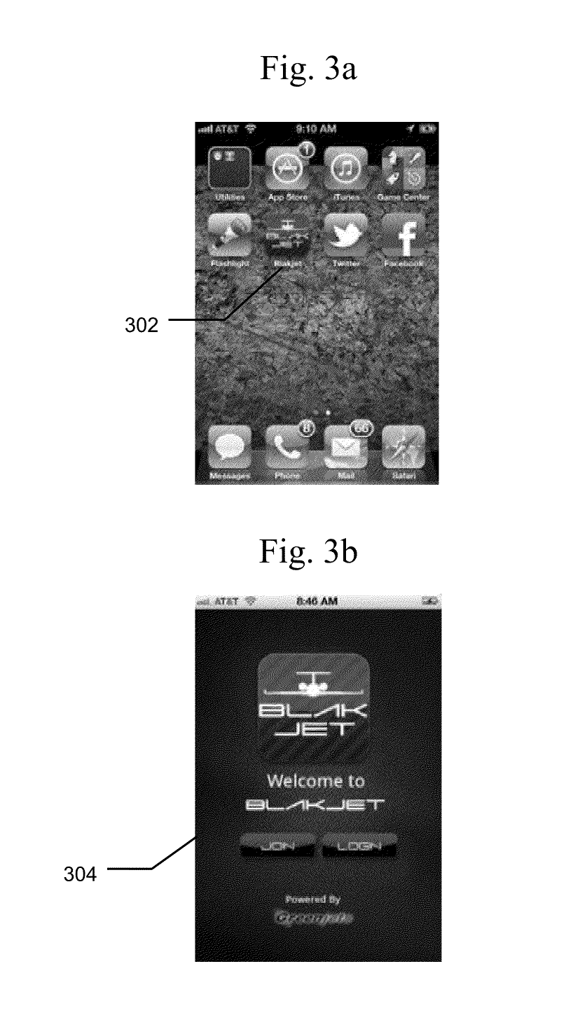

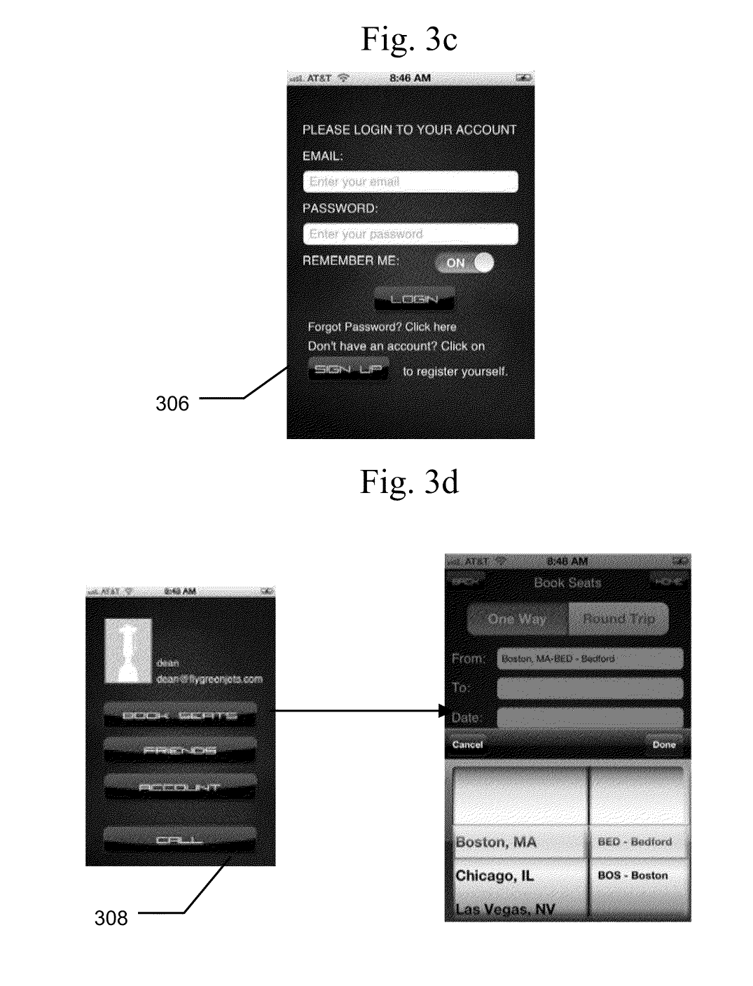

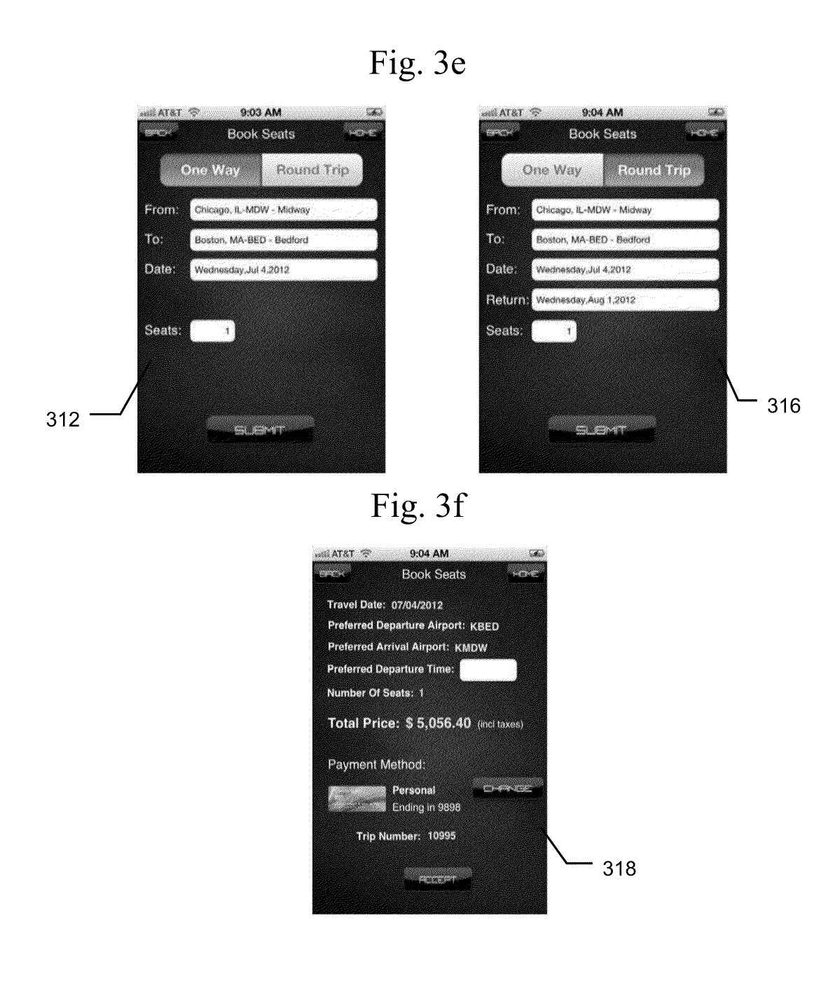

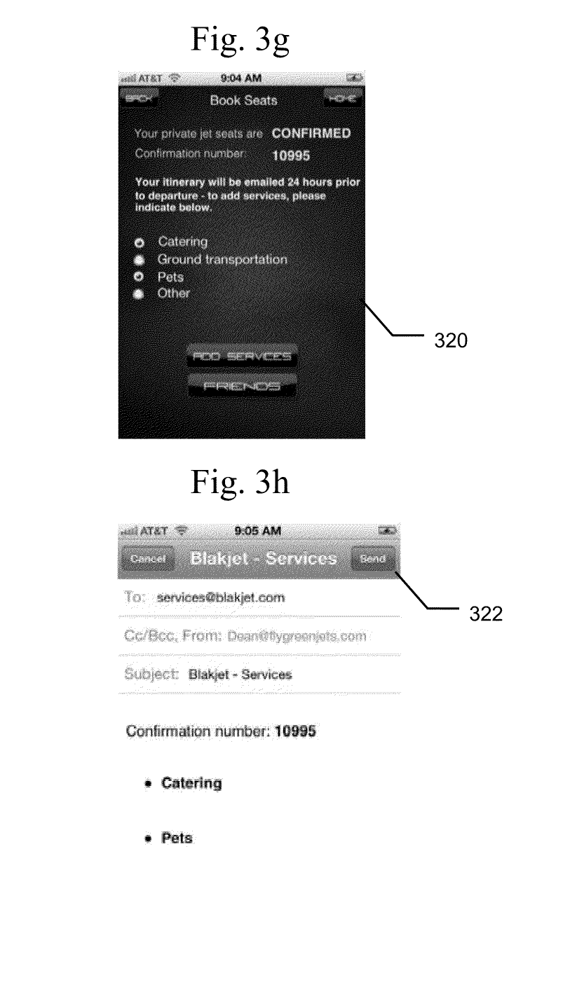

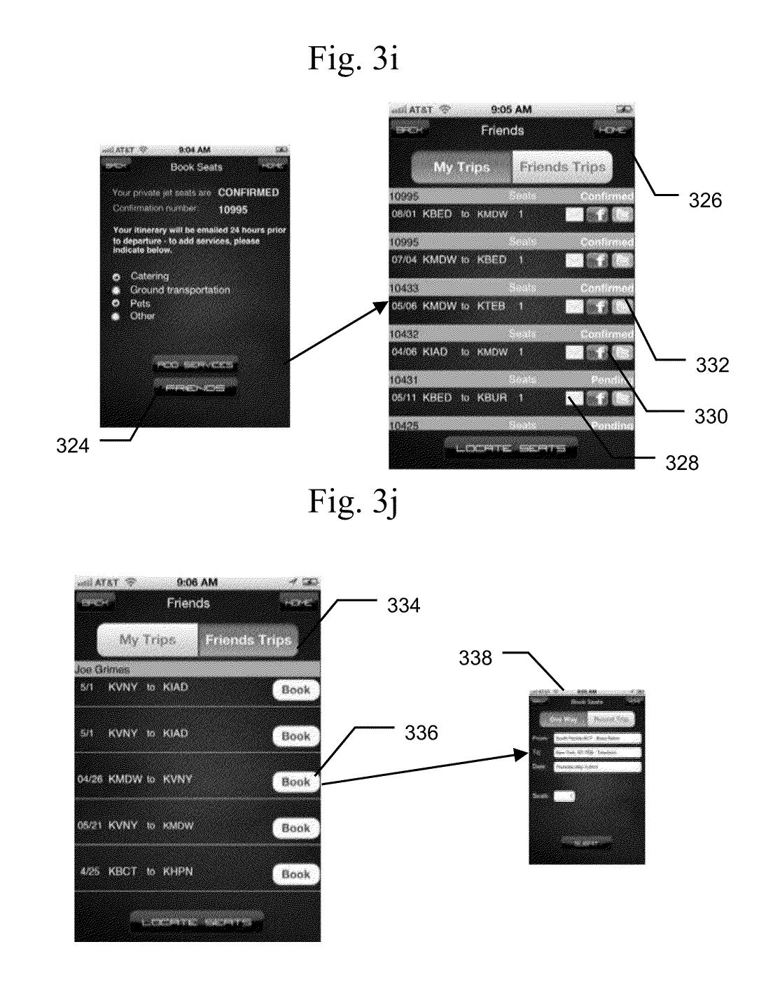

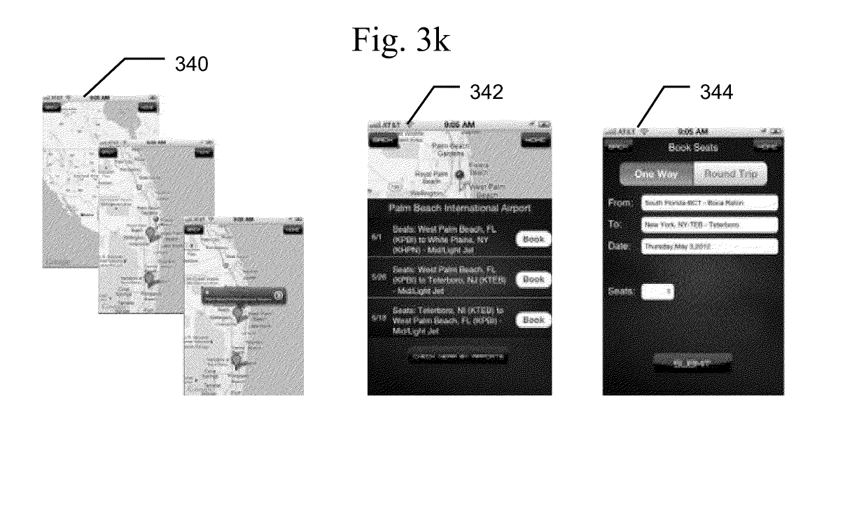

An exemplary flow diagram of a process 200 of booking one or more seats on an aggregated transport service is shown in FIG. 2a. It is best viewed in conjunction with FIGS. 3a-3k, which are illustrations of exemplary display screens illustrating steps in process 200. Process 200 begins with step 202 in which a client of the aggregated transport booking service accesses the system. For example, referring to FIG. 3a, a user of a mobile device may select an app 302, which provides access to the aggregated transport booking service system. Upon launching, the app may display a join/login screen 304, shown in FIG. 3b, which provides the capability for a current client to login, or for a new client to join the service. In the case that the “Login” button is selected, login screen 306, shown in FIG. 3c, may be displayed.

Once a client has logged-in, a number of functions are available to the client, such as those shown in function screen 308, shown in FIG. 3d. Upon selection of, for example, the Book Seats function button 310, a Book Seats screen 312 may be displayed. Book Seats screen 312 provides the capability for the client to indicate origin and destination markets, locations, vicinities, or other geographic area for a desired trip, step 204, shown in FIG. 2. In step 206, Book Seats screen 312 may also provide the capability for the client to indicate a desired date for the trip and optionally, to indicate whether the trip is one way or round trip. Exemplary one way 314 and round trip 316 screens are shown in FIG. 3e. In step 208, the capability may optionally be provided for the client to indicate a preferred departure time window on the date indicated in step 206, for example, as shown in FIG. 3f. In step 210, Book Seats screen 312 may provide the capability for the client to indicate a number of seats to be booked. Upon submission of a Book Seats request, the client may be offered an opportunity to pay a membership fee, as shown in FIG. 3f.

After submission of a Book Seats request indicating origin and destination markets for the desired trip the aggregated transport booking service system may select the preferred airports or other departure and arrival facilities to be used by an aircraft or other transport. Typically, unscheduled air transport utilizes a variety of airports, such as commercial airports, non-commercial airports, community airports, private airfields, etc. The aggregated transport booking service system stores information on such airports and may select the preferred airports to be used for the trip based on factors such as the dates of the trip, the distance between the markets, the types of aircraft that may be used, etc. In step 212, a proposed itinerary is created and a proposed itinerary screen 318, shown in FIG. 3f, may be displayed. Proposed itinerary screen 318 may include information such as the travel date, the selected preferred departure airport, and the selected preferred arrival airport, etc. Further in step 212, the client accepts the itinerary and confirms the booking. Likewise, in step 214, the client arranges payment for the booked transport. In addition, as shown in FIG. 3f, the client may be asked to enter a preferred departure time and to enter or confirm payment information, such as a credit card number, etc. The preferred departure time is merely a request on the part of the client. The actual timing of the trip is determined by unscheduled transport booking service operator based on factors such as the aircraft availability, other aircraft trips being made, other passengers on particular aircraft, etc.

The arranged payment may take a number of forms. For example, a credit card may be used to pay for the arranged transport. In this case, a pre-authorization or reserve of the entire amount due may be placed on the client's selected credit card or other payment medium. Other examples of payment arrangements may include debit cards, checks, credit arrangements, etc. The present invention contemplates and all types of payment arrangements.

Upon successful booking and payment arrangement, in step 215, a confirmation screen 320, shown in FIG. 3g, may be displayed. Confirmation screen 320 may include a confirmation number, and may provide the capability for the client to select optional services, such as catering, ground transportation, pet service, etc. In addition, a confirmation email, such as confirmation email 322, shown in FIG. 3h, may be provided to the client. Confirmation email 322 may include the confirmation number, the selected optional services, etc., and provide the capability for the client to specify details about the selected optional services, such as menu items for catering, the number, and size/breed of pets, ground transportation, or other services.

Once the client has accepted the itinerary the travel is booked on the indicated travel date and between the selected airports. In order to comply with government regulations, such as 14 CFR part 380 regarding public charters, the aircraft that will be used for the trip is not determined until after the client has confirmed the offered itinerary. Thus, acceptance by a client of the offered trip does not imply booking of a particular seat on a particular aircraft. Rather, such acceptance creates an agreement by the aggregated transport booking service to provide a seat on an unspecified aircraft that meets the accepted itinerary parameters. The actual aircraft is arranged for after acceptance of an itinerary, preferably just prior to transport, and may take into account other factors, such as the total number of people who have booked seats for a similar itinerary, including imposed and agreed upon flexibility in itinerary times and actual airports used, and other parameters.

Once the itinerary is confirmed, others may be invited to participate in the trip. A client is allowed to tell their friends or others that they are flying somewhere, and can tell them that they can join the trip, or fly on the same itinerary. If others do join the trip and/or itinerary, this may affect the selection of the particular aircraft or other transport used, and it may also affect when the selection and/or arrangement for the aircraft is performed. Further, it is to be noted that the others joining a trip will not necessarily be transported on the same aircraft as the original client. The particular aircraft or other transport used is not selected at the time of booking, but rather, is typically selected only shortly before the trip.

Others may be invited to participate in the trip using, for example, Friends button 324, shown in FIG. 3i. Friends button 324 provides display of Friends screen 326, which provides the capability to inform other of the trip and to invite them to obtain seats on the same itinerary. Multiple client trips may be shown in Friends screen 326. Controls may be provided to allow invitations to be sent using, for example, email, FACEBOOK®, TWITTER®, etc. For example, selection of email button 328 may automatically generate an email including the invitation relating to the indicated trip, along with an address book of possible recipients. Selection of FACEBOOK® button 330 may provide links to or automatically generate a FACEBOOK® post or newsfeed including the invitation, along with a selection of possible recipients. Selection of TWITTER® button 330 may provide links to or automatically generate a TWITTER® invitation, along with a selection of possible recipients. The transmitted emails, posts, newsfeeds, etc., may include links or controls to provide the recipient with the capability to join the trip to which they were invited. Discounts may be offered to such recipients. A client may enter information about friends or others to which the client wishes to be related in the system. This information may be organized, for example, by categories such as Origin/Destination of friends, known frequented destinations, Family, Business, affinity groups (church, gambling, bird watchers, golfers, etc.) and others. In addition, social media and unscheduled transport booking service system data may be mined to provide suggestions for friends or others who have similar travel patterns to be contacted.

Likewise, a client may obtain information about the trips of others using, for example, Friends Trips button 334. Selection of Friends Trips button 334 may display trips booked by others known to the client, and may provide the capability to book seats on those trips, even without an invitation. For example, selection of Book button 336 may provide display of booking screen 338, with the corresponding trip information already filled in.

In step 216, the booked clients received the final itinerary prior to transport. The final itinerary includes the actual time of transport and the precise locations to and from which the transport is to be provided. In step 218, the client receives the transport service. At some time after the first seat for the trip is booked, but before the trip is to occur, the aggregated transport booking service selects and arranges for a particular vehicle to perform the transport. Such selection and arrangement typically occurs soon before the trip is to occur. Factors relevant to selection of a vehicle may include the origin and destination airports, the distance between the origin and destination airports, the date of transport, the price of the transport, the cost and availability of a particular vehicle, the amount of time until transport is to occur, the number of people who will travel on the same equipment, special requests of any of the travelers, and other considerations. The aggregated transport booking service may change the particular vehicle to be used at any time before transport is to occur, with or without notice to the travelers. Factors relevant to changing the vehicle may include those relevant to initial selection of equipment, as well as other factors.

As another example, the selection of the vehicle may be determined through a bidding process, whereby the agent, broker, online service, aggregator, or directory service provides an opportunity for vehicle operators to be informed of a transport need according to the aggregated travelers needs. The vehicle operators may then bid for the right to provide the transport service. A bid can be for a single trip or multiple trips based on logistics and aggregation already accomplished by the agent, broker, online service, aggregator, or directory service alone or in concert with the operator.

Finally, in step 220, shown in FIG. 2, after the transport has been completed, payment is captured. For example, if the client's credit card was pre-authorized for the amount of the payment, the pre-authorized payment may be captured and the charged amount debited to the client's credit card. If other payments arrangements were made, they are finalized and the payment is captured. This may occur automatically at a predetermined period of time after the transport has occurred.

An exemplary flow diagram of a process 250 of aggregating transport service is shown in FIG. 2b. Process 250 begins with step 252, in which transport requests are received from one or more clients using a process such as that shown in steps 202-214 of FIG. 2a. These transport requests may be received independently, as a group, in response to invitations sent be one client to others, etc. In step 254, the transport requests are accepted and booking confirmations are sent to each of the one or more clients.

At some later point in time, the confirmed bookings are aggregated to determine the vehicles that are needed to provide transport for the confirmed bookings. The bookings are aggregated based on factors such as the date of departure, the departure location, the arrival location, number of aggregated seats booked, and other parameters. If additional bookings are received that may be accommodated by an existing booking or aggregated booking, those bookings may be additionally aggregated.

In step 258, the aggregated transport booking service selects and arranges for a particular vehicle to provide transport for an aggregated itinerary. Such selection and arrangement typically occurs soon before the transport is to occur. Factors relevant to selection of a vehicle may include the origin and destination airports, the distance between the origin and destination airports, the date of transport, the price of the transport, the cost and availability of a particular vehicle, the amount of time until the transport is to occur, the number of people who will travel on the same equipment, special requests of any of the travelers, etc. The aggregated transport booking service may change the particular vehicle to be used at any time before the transport is to occur, with or without notice to the travelers. Factors relevant to changing the vehicle may include those relevant to initial selection of equipment, as well as other factors.

As another example, the selection of the vehicle may be determined through a bidding process, whereby the agent, broker, online service, aggregator, or directory service provides an opportunity for vehicle operators to be informed of a transport need according to the aggregated travelers needs. The vehicle operators may then bid for the right to provide the transport service. A bid can be for a single trip or multiple r trips based on logistics and aggregation already accomplished by the agent, broker, online service, aggregator, or directory service alone or in concert with the operator.

In step 260, final itineraries are provided to all aggregated, booked clients prior to transport. The final itinerary includes the actual time of transport and the precise locations to and from which the transport is to be provide.

Finally, in step 262, shown in FIG. 2, after the transport has been completed, payment is captured. For example, if the client's credit card was pre-authorized for the amount of the payment, the pre-authorized payment may be captured and the charged amount debited to the client's credit card. If other payments arrangements were made, they are finalized and the payment is captured. This may occur automatically at a predetermined period of time after the transport has occurred.

It is to be noted that although processes 200 and 250 have been described in the in the context of a fully functioning data processing system, the present invention contemplates embodiments in which some or all of the process steps are performed manually. Each step may be performed manually, in person, over the telephone, with computer assistance, or automatically by a computer system. The present invention contemplates any and all such embodiments.

Additional considerations in the operation of the aggregated transport booking service may include:

Flexibility—the policies of the aggregated transport booking service may require flexibility on departure time, airport for origin/destination/ or other parameters. Clients can agree to be subject to flexibility in their travel bookings including parameters such as departure time, airports, aircraft, etc., allowing for aggregation and greater optimization. The flexibility requirements may be built into the technology, and may be relaxed as the user-base becomes larger since more users result in more flights, which means less flexibility is required of clients for the same operating economics.

Transport pricing may be established without regard for specific aircraft availability, arrangement with operators or actual availability of aircraft. As no vehicle is determined at the time of booking, pricing may be based on general operating cost calculations, flight times, aggregation factors, and other parameters. The ability to publish guaranteed pricing eliminates a lag time between when a client places a travel request and when it is confirmed, which improves the customer's experience, and increases sell through, Further, the aggregated transport booking service may determine reasonable load factors such as how many passengers will be on the aircraft and provide seat pricing based on an understanding of the probability of aggregated bookings.

Additional useful features may be provided by the app. For example, seat location by geographic location may be provided, as shown in FIG. 3k. Maps 340 are displayed, including indications of available airports in the vicinity. Selection of an airport may cause display 342 of trips that are available from that airport. Selection of an available trip may cause display of booking screen 344, with the corresponding itinerary information already filled in and from which the trip may be booked. The search location, radius of search, etc may be varied.

As another example, rewards may be offered automatically for Inviting Friends, Booking on Friends Trips, Friends joining as Members, and other aspects of promoting members to INVITE friends. This is a Social aspect of the App. Rewards may include a credit against an Annual Membership, free seats, free companion seats, etc. Rewards may be 1-time rewards, or reward points may accumulate until a threshold is reached at which a reward is granted. Redemption may be performed by a simple click at time of booking for companion seats or free seats.

The social aspects of the technology provide much greater ability to invite friends, thus increasing aggregation. Also the ability to instantly gratify the inviter with benefits increases the effectiveness of the invite system and delivers more clients and greater aggregation. The social invite system can act as a proxy for a published schedule: when clients invite through social media, they broadcast their itineraries. Even though the company and operator are not publishing schedules, the clients are broadcasting their travel itineraries. While some regulatory regimes limit publishing schedules, there is no regulation prohibiting inviting friends to join a trip. The invite system allows an easy frictionless way for clients to broadcast their travel and invite others, which greatly reduces or eliminates the need for an operator, agent, broker directory service or other stakeholder from publishing a schedule. In addition, the added benefits associated with not having a vehicle scheduled when the client is broadcasting their itineraries, thus effectively complies with the regulations as empty seats on a vehicle are not being sold, just an aggregation of clients and their needs, prior to arranging transport.

The conventional airline optimization strategy and yield management techniques include the concept and practice of over-booking. The airlines deliberately book more seats than are on the aircraft understanding that there will be some cancellations and that they will have to make some concessions to the passengers that show up to the aircraft when there are no seats available. The techniques of the present invention eliminate having to over-book as the number of aircraft and associated seats are matched with the number of aggregated passengers. In so doing, the techniques of the present invention provide the ability to aggregate the passengers and place them on the type and number of aircraft that works best. The process eliminates the inconvenience associated with over-booking, and provides better optimization of aircraft utilization.

The system may have the ability to add a contact or assistant who will be notified of trips, and can manage a client's schedule. The client may also provide permission for contact or assistant to book and pay for trips for client. The contact or assistant may be a work assistant or colleague, a family member, etc.

The system may include a “Favorite Trips” functionality in which past and/or frequent trips are stored for easy booking in future, for notification when someone else booked a similar trip, etc. The data may be used to locate other clients with similar travel habits and suggest friends, offer specials, etc. Rewards may be awarded to the client for booking such trips.

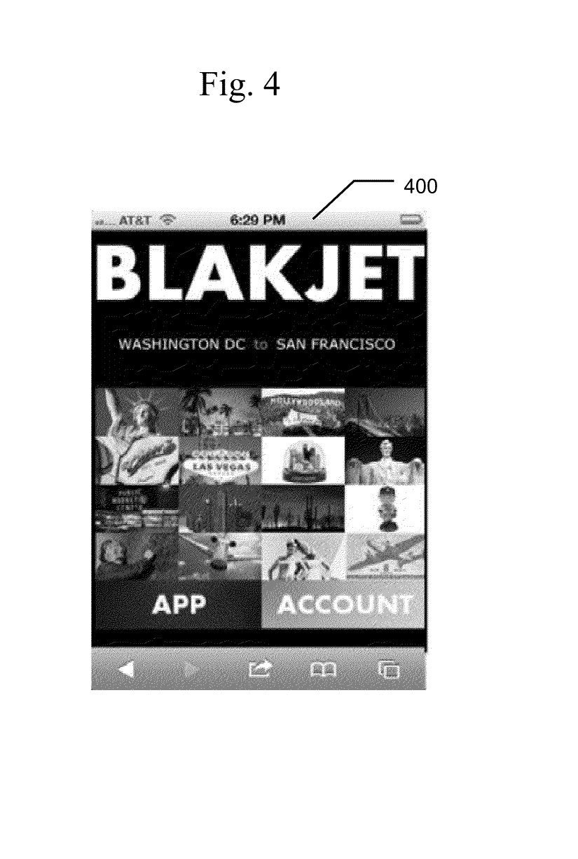

An example of a user interface 400 for a mobile app for booking one or more seats on an aggregated transport service is shown in FIG. 4. In this example, when a client mouses over or clicks an image representing a market an origin market pops up. The destination market is selected similarly, as is the price. When the client clicks on the book icon, the client is taken to the booking function to complete the transaction.

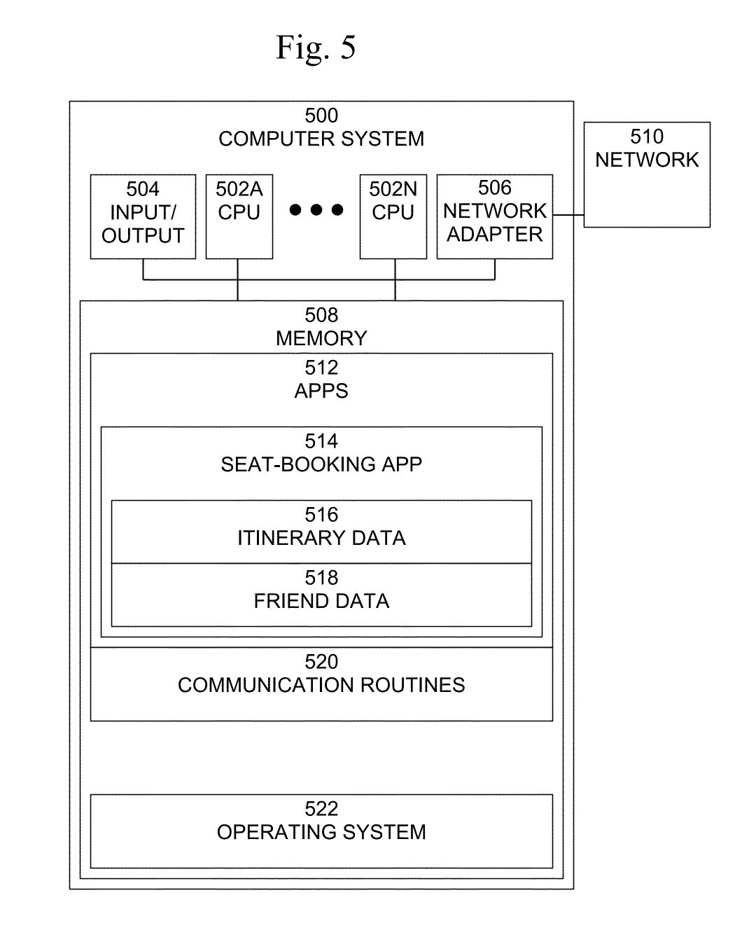

An exemplary block diagram of a mobile device 500, in which an app for booking seats on an aggregated transport service may be implemented, is shown in FIG. 5. Mobile device 500 is typically a small, hand-held computing device, such as a smartphone, feature phone, tablet computer, personal digital assistant, portable media player, etc. Although in this example the structure and function of a mobile device is described in relation to implementation of the present invention, the present invention contemplates the use of any device having user input and output capabilities, and communication capabilities, and thus, implementation in any such device would be similar to that described in this example.

Mobile device 500 may include one or more processors (CPUs) 502A-502N, input/output circuitry 504, network adapter 506, and memory 508. CPUs 502A-502N execute program instructions in order to carry out the functions of the present invention. Typically, CPUs 502A-502N are one or more microprocessors, such as an ARM®, QUALCOMM®, APPLE®, SAMSUNG®, or INTEL® processor. FIG. 5 illustrates an embodiment in which mobile device 500 is implemented as a single multi-processor computer system, in which multiple processors 502A-502N share system resources, such as memory 508, input/output circuitry 504, and network adapter 506. It is to be noted that the present invention contemplates the use of any device having user input and output capabilities, and communication capabilities.

Input/output circuitry 504 provides the capability to input data to, or output data from, database/system 500. For example, input/output circuitry may include input devices, such as keyboards, mice, touchpads, trackballs, scanners, etc., output devices, such as video adapters, monitors, printers, etc., and input/output devices, such as, modems, etc. Network adapter 506 interfaces device 500 with network 510. Network 510 may be any standard local-area or wide-area communications or tele-communications network, whether wired or wireless, or public, private, or proprietary. Typically network 510 may include the Internet, along with one or more other networks.

Memory 508 stores program instructions that are executed by, and data that are used and processed by, CPU 502 to perform the functions of system 500. Memory 508 may include electronic memory devices, such as random-access memory (RAM), read-only memory (ROM), programmable read-only memory (PROM), electrically erasable programmable read-only memory (EEPROM), flash memory, Secure Digital (SD) memory, Compact Flash (CF) memory etc., and electro-mechanical memory, such as magnetic disk drives, tape drives, optical disk drives, etc., which may use an integrated drive electronics (IDE) interface, or a variation or enhancement thereof, such as enhanced IDE (EIDE), Serial ATA (SATA) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 508 vary depending upon the functions that mobile device 500 is programmed to perform. In the example shown in FIG. 5, memory 508 may include apps 512, which may include seat-booking app 514, communication routines 520, and operating system 524. Apps 512 include application software routines that implement various functionality in the mobile device. One such app may be seat-booking app 514, which may implement aspects of the process shown in FIG. 2 to provide the capability for a client of an aggregated transport booking service to utilize the service. Seat-booking app 514 may include or access data, such as itinerary data 516 and friend data 518. Itinerary data 516 may include information relating to proposed, tentative, confirmed, and past itineraries, such as the travel date, the departure airport, the arrival airport, the departure time, etc. Friend data 518 may include information relating to friends or others to which the client wishes to be related in the system and may include identifying and personal information about each person, Origin/Destination of each person, known frequented destinations, Family, Business, affinity groups (church, gambling, bird watchers, golfers, etc.) and other information. Communication routines 520 provide the capability for mobile device 500 to communicate with an aggregated transport booking service system 112, such as is shown in FIG. 1. Operating system 522 provides overall system functionality.

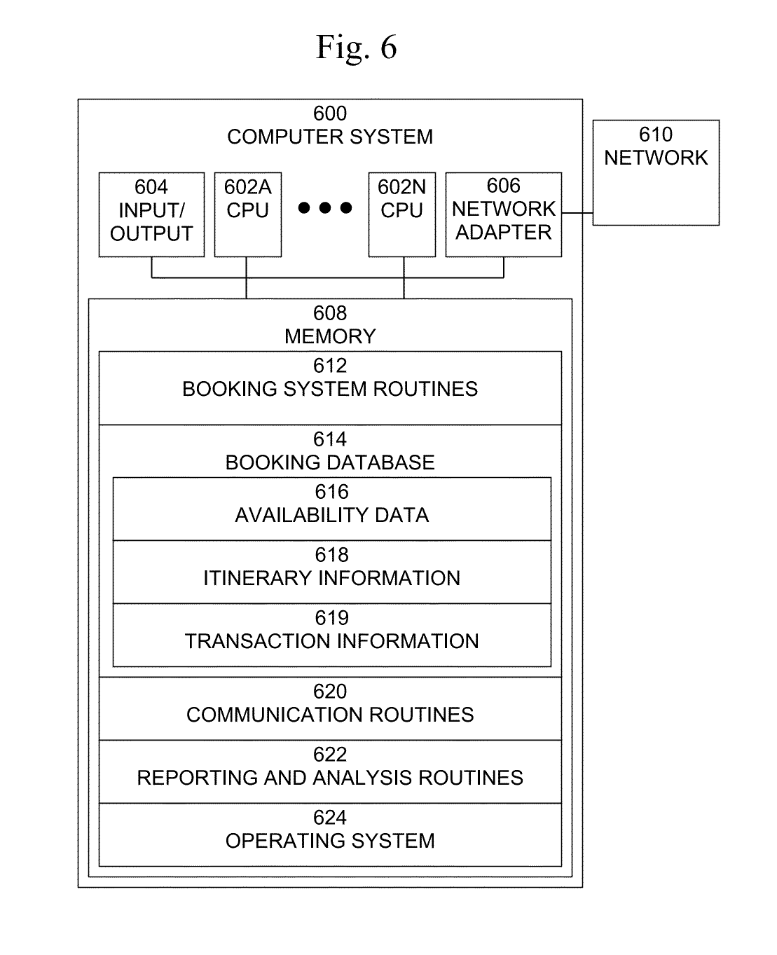

An exemplary block diagram of a computer system 600, in which an aggregated transport booking service system may be implemented, is shown in FIG. 6. System 600 is typically a programmed general-purpose computer system, such as a personal computer, workstation, server system, or minicomputer or mainframe computer. System 600 may include one or more processors (CPUs) 602A-602N, input/output circuitry 604, network adapter 606, and memory 608. CPUs 602A-602N execute program instructions in order to carry out the functions of the present invention. Typically, CPUs 602A-602N are one or more microprocessors, such as an INTEL PENTIUM® processor. FIG. 6 illustrates an embodiment in which System 600 is implemented as a single multi-processor computer system, in which multiple processors 602A-602N share system resources, such as memory 608, input/output circuitry 604, and network adapter 606. However, the present invention also contemplates embodiments in which system 600 is implemented as a plurality of networked computer systems, which may be single-processor computer systems, multi-processor computer systems, or a mix thereof. The computer system or systems may be at one or more physical locations. Typical examples of physical locations may include premises of the promotional system operator, a single or multiple local or remote “server farms”, at a plurality of distributed locations, or in the cloud. Such computer systems may be provided and operated by the promotional system operator, or they may be provided and operated by a computing service vendor. One such example is cloud computing, which is the use of computing resources, such as hardware and software, that are delivered as a service over a network, such as the Internet, or other public or private network. Examples of typical cloud computing services include Infrastructure as a service (IaaS), Platform as a service (PaaS), Software as a service (SaaS), and Storage as a service (STaaS). The present invention contemplates any physical location of computer systems and networks, as well as any physical or logical provision, operation, or implementation of computer systems and networks.

Input/output circuitry 604 provides the capability to input data to, or output data from, database/system 600. For example, input/output circuitry may include input devices, such as keyboards, mice, touchpads, trackballs, scanners, etc., output devices, such as video adapters, monitors, printers, etc., and input/output devices, such as, modems, etc. Network adapter 606 interfaces device 600 with network 610. Network 610 may be any standard local-area or wide-area communications or telecommunications network, whether wired or wireless, or public, private, or proprietary. Typically network 610 may include the Internet, along with one or more other networks.

Memory 608 stores program instructions that are executed by, and data that are used and processed by, CPU 602 to perform the functions of system 600. Memory 608 may include electronic memory devices, such as random-access memory (RAM), read-only memory (ROM), programmable read-only memory (PROM), electrically erasable programmable read-only memory (EEPROM), flash memory, Secure Digital (SD) memory, Compact Flash (CF) memory etc., and electro-mechanical memory, such as magnetic disk drives, tape drives, optical disk drives, etc., which may use an integrated drive electronics (IDE) interface, or a variation or enhancement thereof, such as enhanced IDE (EIDE), Serial ATA (SATA) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 608 vary depending upon the function that system 600 is programmed to perform. In the example shown in FIG. 6, memory 608 may include booking system routines 612, booking database 614, communication routines 620, reporting and analysis routines 622, and operating system 624. Booking system routines 612 include software implementing the functionality of the booking system, such as aspects of the process shown in FIG. 2, such as software for determining transport availability, for creating itineraries for clients, for computing reward information, for operating and maintaining booking database 614, for completing payment transaction with clients, etc. Booking database 614 may include availability data 616, itinerary information 618, and transaction data 619. Availability data 616 may include data relating to the availability of transport, existing trip arrangements, seats, airports, etc. that may be used to determine available seats to offer to clients. Itinerary information 618 may include, information relating to proposed, tentative, confirmed and past itineraries of clients of the system, such as the travel date, the departure airport, the arrival airport, the departure time, etc. Transaction data 619 may include information relating to booking, payment, authorization, and reward transactions with clients. Communication routines 620 provide the capability for system 600 to communicate with client devices, such as mobile device 102 and computer system 104, shown in FIG. 1. Reporting and analysis routines provide the capability to analyze availability data 616, itinerary information 618, and transaction data 619 and generate reports regarding operation, usage and, financial aspects of the aggregated transport service. Operating system 624 provides overall system functionality.

As shown in FIG. 6, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a non-transitory computer readable medium of instructions and a variety of other forms and that the present invention applies equally regardless of the particular type of media actually used to carry out the distribution. Examples of non-transitory computer readable media include, but are not limited to, floppy disks, hard disk drives, CD-ROMs, DVD ROMs, ROM, and flash memory.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for booking transport on an aggregated unscheduled transport service performed in a computer system comprising a processor and a memory storing software code, executable by the processor, and data, accessible by the processor, for performing the method comprising:
receiving an indication of an origin, a destination, and a date of transport for transport on an aggregated transport service;
determining a price for the indicated transport;
transmitting information relating to the origin, destination, price, and the date of transport;
receiving an indication that transport using the origin and destination, for the determined price and on the date of transport has been accepted;
in response to receiving the indication that the transport has been accepted, and before a vehicle to provide the indicated transport has been determined, arranging for payment for the transport and transmitting a confirmation of the booking of the indicated transport;
before the indicated transport occurs, determining a vehicle to provide the indicated transport; and
when the indicated transport is completed, capturing the arranged payment.

2. The method of claim 1, further comprising:
before determining the vehicle to provide the transport, aggregating a plurality of confirmed bookings based on factors at least one of a dated of departure, the departure location, and the arrival location; and
determining the vehicle to provide the transport based on the aggregated plurality of confirmed bookings.

3. The method of claim 2, wherein the aggregated unscheduled transport service is an aircraft charter operator, a broker, a travel agent, a directory type service or other intermediary.

4. The method of claim 2, wherein the vehicle is determined based on at least one of an origin or destination of the transport, a distance between the origin and destination of the transport, the date of transport, the cost of the transport, availability of particular vehicles, an amount of time until the transport is to occur, a number of people who will travel on the same equipment, and special requests of any of the travelers.

5. The method of claim 2, wherein the vehicle is determined based on a bidding process in which vehicle operators are informed of a transport need based on the confirmed bookings and the vehicle operators then bid for the right to provide the transport service.

6. A method for booking transport on an aggregated unscheduled transport service performed in a computer system comprising a processor and a memory storing software code, executable by the processor, and data, accessible by the processor, for performing the method comprising:
accepting and transmitting input of an indication of an origin, a destination, and a date of transport for transport on an aggregated transport service wherein no vehicle has been determined for performing the transport; and
accepting and transmitting an indication that transport using the origin and destination, for the determined price, and on the date of transport has been accepted.

7. The method of claim 6, wherein the aggregated unscheduled transport service is an aircraft charter operator, a broker, a travel agent, a directory type service or other intermediary.

8. The method of claim 6, wherein the method is implemented as an application on a mobile device, a web application, or a mobile web application.

9. A computer program product for booking seats on an aggregated unscheduled transport service comprising a non-transitory computer readable medium having recorded thereon computer program instructions, the computer program instructions executable by at least one processor to perform:
receiving an indication of an origin, a destination, and a date of transport for transport on an aggregated transport service;
determining a price for the indicated transport;
transmitting information relating to origin, destination, price, and the date of transport;
receiving an indication that transport using origin and destination, for the determined price and on the date of transport has been accepted;
in response to receiving the indication that the transport has been accepted, and before a vehicle to provide the indicated transport has been determined, arranging for payment for the transport and transmitting a confirmation of the booking of the indicated transport;
before the indicated transport occurs, determining a vehicle to provide the indicated transport; and
when the indicated transport is completed, capturing the arranged payment.

10. The computer program product of claim 9, further comprising computer program instructions to perform:
before determining the vehicle to provide the transport, aggregating a plurality of confirmed bookings based on factors at least one of a dated of departure, the departure location, and the arrival location; and
determining the vehicle to provide the transport based on the aggregated plurality of confirmed bookings.

11. The computer program product of claim 10, wherein the aggregated unscheduled transport service is an aircraft charter operator, a broker, a travel agent, a directory type service or other intermediary.

12. The computer program product of claim 10, wherein the vehicle is determined based on at least one of an origin or destination of the transport, a distance between the origin and destination of the transport, the date of transport, the cost of the transport, availability of particular vehicles, an amount of time until the transport is to occur, a number of people who will travel on the same equipment, and special requests of any of the travelers.

13. The computer program product of claim 10, wherein the vehicle is determined based on a bidding process in which vehicle operators are informed of a transport need based on the confirmed bookings and the vehicle operators then bid for the right to provide the transport service.

14. A computer program product for booking transport on an aggregated unscheduled transport service comprising a non-transitory computer readable medium having recorded thereon computer program instructions, the computer program instructions executable by at least one processor to perform:
accepting and transmitting input of an indication of an origin, a destination, and a date of transport for transport on an aggregated transport service wherein no vehicle has been determined for performing the transport; and
accepting and transmitting an indication that transport using the origin and destination, for the determined price, and on the date of transport has been accepted.

15. The computer program product of claim 14, wherein the aggregated unscheduled transport service is an aircraft charter operator, a broker, a travel agent, a directory type service or other intermediary.

16. The computer program product of claim 14, wherein the method is implemented as an application on a mobile device, a web application, or a mobile web application.

17. A system for booking transport on an aggregated unscheduled transport service comprising a processor operable to execute computer program instructions, a memory operable to store computer program instructions executable by the processor, and computer program instructions stored in the memory and executable to perform:
receiving an indication of an origin, a destination, and a date of transport for transport on an aggregated transport service;
determining a price for the indicated transport;
transmitting information relating to the origin, destination, price, and the date of transport;
receiving an indication that transport using the origin and destination, for the determined price and on the date of transport has been accepted;
in response to receiving the indication that the transport has been accepted, and before a vehicle to provide the indicated transport has been determined, arranging for payment for the transport and transmitting a confirmation of the booking of the indicated transport;
before the indicated transport occurs, determining a vehicle to provide the indicated transport; and
when the indicated transport is completed, capturing the arranged payment.

18. The system of claim 17, further comprising computer program instructions to perform:
before determining the vehicle to provide the transport, aggregating a plurality of confirmed bookings based on factors at least one of a dated of departure, the departure location, and the arrival location; and
determining the vehicle to provide the transport based on the aggregated plurality of confirmed bookings.

19. The system of claim 18, wherein the aggregated unscheduled transport service is an aircraft charter operator, a broker, a travel agent, a directory type service or other intermediary.

20. The system of claim 18, wherein the vehicle is determined based on at least one of an origin or destination of the transport, a distance between the origin and destination of the transport, the date of transport, the cost of the transport, availability of particular vehicles, an amount of time until the transport is to occur, a number of people who will travel on the same equipment, and special requests of any of the travelers.

21. The system of claim 18, wherein the vehicle is determined based on a bidding process in which vehicle operators are informed of a transport need based on the confirmed bookings and the vehicle operators then bid for the right to provide the transport service.

22. A system for booking transport on an aggregated unscheduled transport service comprising a processor operable to execute computer program instructions, a memory operable to store computer program instructions executable by the processor, and computer program instructions stored in the memory and executable to perform:
accepting and transmitting input of an indication of an origin, a destination, and a date of transport for transport on an aggregated transport service wherein no vehicle has been determined for performing the transport; and
accepting and transmitting an indication that transport using the origin and destination, for the determined price, and on the date of transport has been accepted.

23. The system of claim 22, wherein the aggregated unscheduled transport service is an aircraft charter operator, a broker, a travel agent, a directory type service or other intermediary.

24. The system of claim 22, wherein the method is implemented as an application on a mobile device, a web application, or a mobile web application.
